(19) United States
(12) Patent Application Publication
(10) Pub. No.: US 2024/0104699 A1
(43) Pub. Date: Mar. 28, 2024

(54) Generating A Gallery View From An Area View

(71) Applicant: Microsoft Technology Licensing, LLC, Redmond, WA (US)

(72) Inventors: Karen MASTER BEN-DOR, Kfar Saba (IL); Eshchar ZYCHLINSKI, Tel Aviv (IL); Stav YAGEV, Tel Aviv (IL); Yoni SMOLIN, Yokneam Illit (IL); Raz HALALY, Ness Ziyona (IL); Adi DIAMANT, Tel Aviv (IL); Ido LEICHTER, Haifa (IL); Tamir SHLOMI, Hadera (IL)

(21) Appl. No.: 17/950,985

(22) Filed: Sep. 22, 2022

(51) Int. Cl. G06T 5/00; G06T 3/40; G06T 5/20; G06T 11/00; G06V 10/26; G06V 20/40

(52) U.S. Cl. CPC G06T 5/002; G06T 3/40; G06T 5/20; G06T 11/00; G06V 10/26; G06V 20/44; G06T 2207/10016

(57) ABSTRACT

Techniques for generating a gallery view of tiles for in-area participants who are participating in an online meeting are disclosed. A video stream is accessed, where this stream includes an area view of an area in which an in-area participant is located. This area view comprises pixels representative of the area and pixels representative of the in-area participant. The pixels representative of the in-area participant are identified. A field of view of the in-area participant is generated. A tile of the in-area participant is generated based on the field of view. This tile is then displayed while the area view is not displayed.

### BACKGROUND

The COVID-19 pandemic resulted in many significant changes to how people work and collaborate. One particular change dealt with the increased usage of online meeting platforms (aka video conferencing). As an example, the number of daily participants who used one type of online meeting platform in late 2019 was on average about 10 million. Four months later, however, the number of daily users increased to over 300 million.

Many businesses have now returned to the office, at least in part. With that return, meetings are now being held in a hybrid manner, with some people being in-office while others are working remotely. Everybody is able to meet and collaborate with one another via the video conferencing platform.

One issue that has arisen with video conferencing is that online participants are often provided with higher levels of individualized exposure as compared to the in-room (aka “in-area”) participants. For instance, consider a scenario where a conference room has a front-facing camera. The camera generates a feed that is often quite expansive so as to cover everybody in the room. This room-based feed is then displayed in the video conference. The online participants, on the other hand, typically have a camera that is generally focused on that person. The result is that the visual appearance and behavior of the online person is more readily viewable as compared to that of the in-room participant. What is needed, therefore, is a technique for improving the video conferencing experience so as to provide a heightened or improved experience, particularly for the in-room participants.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Embodiments disclosed herein relate to systems, devices, and methods for generating a gallery-based tile of one or more participants who are participating in an online meeting. The tile is displayed in a gallery view, along with potentially any number of other tiles or tile types. Tiles can display any type of content. A tile that displays an expansive area or room view can be considered as an “area-based tile.” A tile that displays a focused view of a participant can be considered as a “gallery-based tile.”

Some embodiments access or receive a video stream comprising an area view of an area in which a participant is located. This area view comprises first pixels that are representative of the area and second pixels that are representative of the participant. The area view is segmented to identify the second pixels that are representative of the participant. A field of view that surrounds a selected portion of the second pixels representative of the participant is also generated. Based on an occurrence of a defined event, the embodiments generate a gallery-based tile of the participant, where the gallery-based tile is based on the field of view. The embodiments also cause the gallery-based tile of the participant to be displayed while refraining from displaying an area-based tile comprising the area view.

Some embodiments access or receive a video stream comprising an area view of an area in which a first in-area participant and a second in-area participant are located. This area view comprises first pixels that are representative of the first in-area participant and second pixels that are representative of the second in-area participant. An area-based tile comprising the area view is displayed. The embodiments segment the area view to identify the first pixels that are representative of the first in-area participant and to identify the second pixels that are representative of the second in-area participant. The embodiments generate a first field of view that surrounds a first selected portion of the first pixels representative of the first in-area participant and a second field of view that surrounds a second selected portion of the second pixels representative of the second in-area participant. A determination is made that the second field of view overlaps the first field of view. The embodiments also determine that an amount of overlap between the first field of view and the second field of view exceeds an overlap threshold. A merged tile is generated based on a third field of view. The third field of view comprises a combination of the first field of view and the second field of view. The embodiments then cause the merged tile of the first in-area participant and of the second in-area participant to be displayed while refraining from displaying the area-based tile comprising the area view.

Some embodiments access or receive a video stream of an online meeting. This video stream comprises an area view of an area in which a first in-area participant is located. The area view comprises first pixels that are representative of the first in-area participant. The embodiments cause an area-based tile comprising the area view to be displayed in a user interface for the online meeting. The embodiments also segment the area view to identify the first pixels that are representative of the first in-area participant. A first field of view is generated, where this first field of view surrounds a selected portion of the first pixels representative of the first in-area participant. The embodiments generate a first gallery-based tile of the first in-area participant based on the first field of view. The first gallery-based tile of the first in-area participant is caused to be displayed. Notably, however, the embodiments refrain from displaying the area-based tile comprising the area view. The first gallery-based tile is displayed simultaneously with one or more gallery-based tiles of online participants. The embodiments detect, within the area view of the video stream, second pixels that are representative of a second in-area participant who has newly entered the area. Based on this detection, the embodiments cause the area-based tile comprising the area view to be displayed simultaneously with the one or more gallery-based tiles of the online participants while refraining from displaying the first gallery-based tile.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example of an area view.

FIG. 2 illustrates a user interface of an online meeting.

FIG. 3 illustrates how various in-area participants are in the room.

FIG. 4 illustrates how the in-area participants can be identified.

FIG. 5 illustrates examples of how many pixels are used to illustrate a participant's face.

FIG. 6 illustrates various scaling factors that can be applied.

FIG. 7 illustrates examples of gallery-based tiles of participants displayed within a gallery view.

FIG. 8 illustrates how a gallery-based tile can be provided even when a participant moves.

FIG. 9 illustrates an example of an event that triggers the re-display of an area-based tile comprising the area view in lieu of the gallery view that included different gallery-based tiles.

FIG. 10 illustrates how an in-area participant is still moving.

FIG. 11 illustrates how the display of the gallery-based tiles of the in-area participants can be delayed for a period of time until the participants are generally stationary for a determined buffer time.

FIG. 12 illustrates another example of various gallery-based tiles in a gallery view.

FIG. 13 illustrates a scenario where the field of view for one participant overlaps the field of view for another participant.

FIG. 14 illustrates the level of overlap.

FIG. 15 illustrates how a new field of view can be generated, where this new field of view encompasses the fields of view of both of the participants.

FIG. 16 illustrates a merged tile that is displayed in a gallery view.

FIG. 17 illustrates how a field of view can be generated based on a template field of view.

FIG. 18 illustrates the template based field of view.

FIGS. 19A, 19B, and 19C illustrate various templates.

FIG. 20 illustrates a blurring effect that can be used to blur duplicate content that is included in multiple gallery-based tiles.

FIG. 21 illustrates a flowchart of an example method for generating gallery-based tiles from an area view.

FIG. 22 illustrates a flowchart of an example method for generating a merged tile.

FIG. 23 illustrates a flowchart of an example method for transitioning between an area view to a gallery view, which includes multiple gallery-based tiles, and then back to an area view.

FIG. 24 illustrates an example computer system that can be configured to perform any of the disclosed operations.

### DETAILED DESCRIPTION

Embodiments disclosed herein relate to systems, devices, and methods for generating a gallery view comprising gallery-based tiles of one or more in-area participants who are participating in an online meeting. A tile that displays an expansive area or room view can be considered as an “area-based tile.” A tile that displays a focused view of a participant (though potentially more than one participant can be included) can be considered as a “gallery-based tile.” A gallery-based tile can display content for a remote participant or content for an in-area participant. Thus, an area-based tile comprising an area view can be displayed simultaneously with a gallery-based tile (e.g., one for a remote participant). That being said, the embodiments intelligently generate gallery-based tiles from an area view and then determine when to display only the gallery-based tiles. Displaying gallery-based tiles in lieu of the area-based tile provides various benefits in that the gallery-based tiles provide an enhanced visualization of the in-area participants whereas those in-area participants can sometimes be lost or otherwise not emphasized within the expansive view of the area-based tile. Thus, while an area-based tile can be displayed simultaneously with a gallery-based tile, there are various advantages to displaying only gallery-based tiles.

Some embodiments access or receive a video stream comprising an area view of an area in which a participant is located. The term “access” can include accessing a video stream that is received from a remote device or source. This area view comprises pixels representative of the area and pixels representative of the participant. The pixels representative of the participant are identified. A field of view of the participant is generated. The embodiments generate a gallery-based tile of the participant. The gallery-based tile is then displayed while an area-based tile comprising the area view is not displayed. Notably, at the time of the creation of the gallery-based tile, the embodiments are able to identify all of the in-area participants and create multiple gallery-based tiles.

Some embodiments access or receive a video stream comprising an area view of an area in which a first in-area participant and a second in-area participant are located. An area-based tile comprising the area view is displayed. The area view is segmented to identify pixels representative of the first in-area participant and pixels representative of the second in-area participant. A first field of view is generated for the first in-area participant and a second field of view is generated for the second in-area participant. The second field of view overlaps the first field of view. An amount of the overlap exceeds an overlap threshold. A merged tile is generated by combining the first and second fields of view. The merged tile is displayed while the area-based tile comprising the area view is prevented from being displayed.

Some embodiments access or receive a video stream of an online meeting. This video stream comprises an area view of an area in which a first in-area participant is located. The area view comprises pixels representative of the first in-area participant. An area-based tile comprising the area view is displayed. The area view is segmented to identify the first in-area participant. A first field of view is generated around the first in-area participant. A first gallery-based tile of the first in-area participant is generated and then displayed. The first gallery-based tile is displayed simultaneously with one or more gallery-based tiles of online participants. A second in-area participant is detected in the area. Based on this detection, the area-based tile comprising the area view is now displayed instead of any gallery-based tiles for any in-area participants. The area-based tile comprising the area view is displayed simultaneously with the gallery-based tiles of the online participants (but not for the in-area participants), resulting in the display of a hybrid interface showing one or more gallery-based tiles for the online participants and the area-based tile comprising the area view.

### Examples of Technical Benefits, Improvements, and Practical Applications

The following section outlines some example improvements and practical applications provided by the disclosed embodiments. It will be appreciated, however, that these are just examples only and that the embodiments are not limited to only these improvements.

The disclosed embodiments beneficially improve the use of an online meeting platform. In today's age, people are increasingly using online meeting platforms to meet and collaborate. These platforms provide the option for individuals to join the meeting individually as well as in a group, such as in a conference room. The participants who join in the group can sometimes be overshadowed or lost. The disclosed embodiments beneficially provide various mechanisms for ensuring the in-room or “in-area” participants are provided equal screen real estate in the online meeting platform. As a result, the embodiments significantly improve the online meeting experience for all of the participants.

The disclosed embodiments beneficially are directed to an improved hybrid workspace viewer that better merges meeting rooms with online participants. Various advantages are realized by practicing the disclosed principles. For instance, remote participants are now better able to understand the dynamic in the room by seeing larger faces and by easily focusing on the person or participant who is talking in the room. Participants are better able to view facial expressions and body language of all the participants, even when those participants are silent. In room participants will also be provided with a better or at least equal presence in the video gallery (e.g., similar to the level of exposure online participants are provided).

Generally, participants can be presented within their own dedicated tile as opposed to having to be a part of a larger group. As used herein, a “tile” generally refers to a user interface element that displays information. A tile can be thought of as a brick or segment of the user interface that includes a width and a height. Tiles generally optimize space and the readability of data, particularly for image data. Tiles can also be interactive. In-room or in-area participants are also provided an enhanced level of focus within their respective tiles when talking. As mentioned previously, a tile that displays an expansive area view can be considered as an “area-based tile.” A tile that displays a focused view of a participant can be considered as a “gallery-based tile.” The embodiments intelligently generate gallery-based tiles from an area view and then determine when to display only the gallery-based tiles. With regard to the figures, when a tile displays the expansive area, then that tile is an area-based tile. When a tile displays one (though potentially more, as in the case of being “merged”), then that tile is a gallery-based tile. While a majority of this disclosure is focused on scenarios involving in-area participants, the disclosed principles can also be employed for online participants. That is, the disclosed principles can be practiced to improve the appearance and experience of an online participant.

The participants are also beneficially provided with a clearer presence when talking. A “gallery view,” as used herein, generally refers to a scenario where the user interface is displaying multiple different gallery-based tiles of individual participants. In some cases, a hybrid view can be provided, such as where a gallery view (comprising multiple gallery-based tiles of individuals) is displayed simultaneously with an area-based tile comprising a room or area view.

In accordance with the disclosed principles, the embodiments are able to implement an intelligence engine (e.g., a room gallery AI engine) that takes the existing room's video and that composes a new gallery-based stream, where this gallery-based stream includes multiple gallery-based tiles. This new stream replaces the room view stream (i.e. the area-based tile) in the online meeting platform. Beneficially, the embodiments are able to intelligently parse out the individual in-area participants and generate a respective gallery-based tile for each in-area participant. These gallery-based tiles are then merged into a single data stream. This single data stream then takes the place of the room view stream. Therefore, although the gallery-based tiles for the in-room or in-area participants appear to be separate tiles in the user interface, those tiles can be included in the same data stream. In some implementations, however, those tiles can optionally be included in separate data streams.

Generally, the embodiments are able to obtain initial fields of view (FOVs) and max scale FOVs (e.g., scaling a FOV to maximize face size based on original resolution, number of pixels that represent a participant's face, or a particular threshold). As another benefit, the embodiments can optionally merge overlapping FOVs based on an overlap threshold. The embodiments are also able to intelligently select a “best” template based on the number of FOVs and based on the sizes of the FOVs and the templates. In some implementations, selecting the best template is based on selecting a template with an optimal face size (e.g., a template that shows a participants face at a largest or a target size). As a result, online participants will be able to perceive the in-area participants in an optimal manner. In some cases, the template of the FOVs can be selected based on the layout or physical positioning of the in-area participants. Some embodiments even prioritize the placement of FOVs in gallery-based tiles. The embodiments are beneficially able to centralize and normalize faces and can provide selective blurring effects for duplicate content. Emphasis can even be provided to a gallery-based tile when that gallery-based tile's participant is the active speaker. The gallery-based tiles can be filled with updated FOV results and can optionally fall back to displaying the area-based tile comprising the room view if the gallery-based tiles cannot be adequately filled without visual gaps. With this user interface, the embodiments provide an improved experience for a user. For instance, the user's interaction with a computer system is improved as a result of the user having the opportunity to better engage with the other participants in the online meeting. As an example, with this user interface, the user will be able to better observe the physical reactions and movements that another user has when participating in the meeting. In this sense, the disclosed user interfaces significantly improve how a user interacts with a computer system. Accordingly, these and numerous other benefits will now be described in more detail throughout the remaining sections of this disclosure.

### Online Meeting Platforms

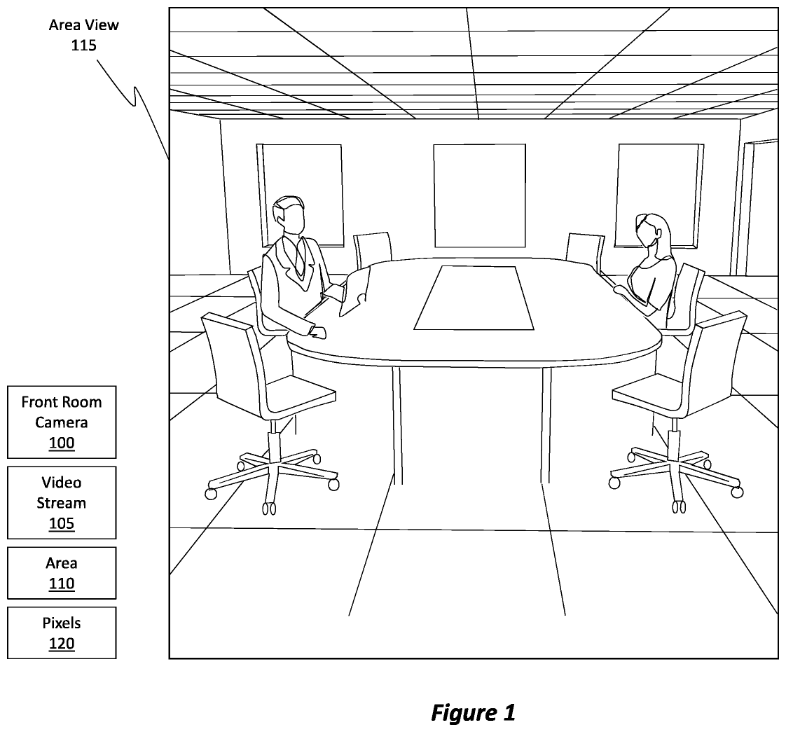

Attention will now be directed to FIG. 1, which shows an example of a front room camera 100 that is generating a video stream 105. The front room camera 100 is directed towards a room or an “area” 110. The video stream 105 comprises a stream of an area view 115. The area view 115 includes pixels 120 of different types of content, including pixels of the room or area and pixels of participants or individuals who are located within the area (e.g., the man and the woman, as shown in FIG. 1).

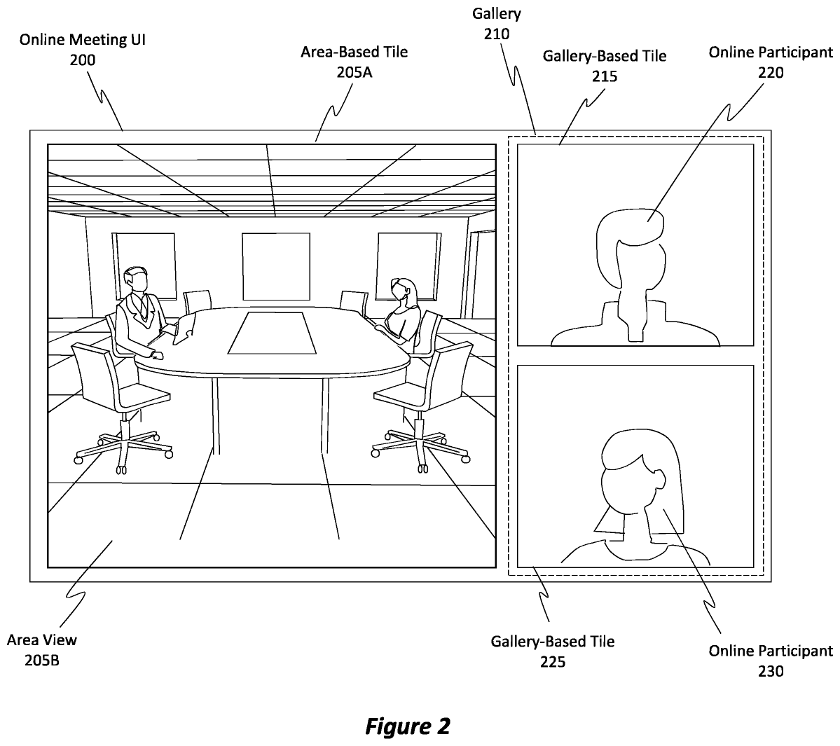

FIG. 2 illustrates an online meeting user interface (UI) 200. This UI 200 is showing an area-based tile 205A comprising an area view 205B, which is representative of the area view 115 from FIG. 1. The area view 205B is an image or includes image content representative of the area or room. In addition to this area-based tile 205A comprising the area view 205B, the UI 200 is showing a gallery 210 comprising multiple gallery-based tiles of individual participants. In this manner, FIG. 2 is showing a hybrid user interface that includes a combination of a room view (e.g., the area view 205B) and the gallery 210. The dashed line representing the gallery 210 is provided for illustration purposes to emphasize the presence of the gallery-based tiles of the individual online participants, and it is likely the case that there will not be a visual distinction to emphasize the gallery (aka gallery view).

The gallery 210 is shown as including a first gallery-based tile 215 of an online participant 220 and a second gallery-based tile 225 of another online participant 230. It is typically the case that the online participants 220 and 230 are not physically located in the area that is represented within the area view 205B.

As introduced earlier, a “gallery” (aka “gallery view”) is distinct from an “area view” (aka “room view”). An “area view” is typically considered to be a representation of an expansive area where multiple participants can optionally be located. A “gallery view,” on the other hand, typically includes one or more gallery-based tiles, where each gallery-based tile is typically focused on a specific participant, such as in the case where a tile shows a zoomed-in representation of a participant. In some scenarios, multiple participants can be visualized within the same gallery-based tile. As mentioned previously, some user interfaces can be hybrid interfaces that include both the area-based tile comprising the area or room view and the gallery view comprising one or more gallery-based tiles. As disclosed herein, the embodiments are beneficially structured to be able to intelligently transition from displaying a room view (or perhaps the hybrid combination of the room view and a gallery view) to displaying only a gallery view that comprises gallery-based tiles of participants while refraining from displaying the room view. The embodiments also include intelligence for determining when a gallery-based tile is to be structured to include multiple participants. Further details on this aspect will be provided later.

In some cases, the majority of pixel content included in the area or room view is that of the area while a minority of the pixel content is that of the participants. For instance, in FIG. 2, the area view 205B includes pixels that represent the table, chairs, floor, ceiling, walls, and the two participants. One can observe how a majority (or at least a relatively large percentage) of the pixel content is directed to the objects that are not participants while a minority (or at least a relatively small percentage) of the pixel content is directed to the participants. In some cases, an “area view” or an area-based tile that comprises the area view can be considered as a representation that does not necessarily emphasize any particular object or participant; rather, the area view is simply an expansive representation. Often, there is no specific area of focus for the area view.

In contrast, a “gallery view” includes gallery-based tiles of individual (though potentially multiple) participants. That is, in a gallery-based tile, a substantial number of the pixels are representative of the participant as opposed to being representative of other objects or matter. For instance, in some cases, the majority (or at least a relatively large percentage) of pixel content included in a gallery-based tile can be that of the participant. To illustrate, consider the gallery-based tile 215 of FIG. 2. Here, one can observe how the emphasis in the image or video is placed on the online participant 220. The gallery-based tile 215 is also generally centralized or focused on the online participant 220 (i.e. the participant is centered in the gallery-based tile 215). Thus, one distinction between gallery-based tiles in a “gallery view” and an area-based tile showing an “area view” is that a gallery-based tile in a gallery view does have a primary point of focus, with that focus being a participant. In contrast, an area-based tile showing the area view generally does not have a primary point of focus but instead the objective of the area view is to generally capture all of the content within a given region or area.

In FIG. 2, the area view 205B (which is included in an area-based tile) is displayed simultaneously with the gallery 210, which includes the gallery-based tiles 215 and 225. From this illustration, one can generally observe how the online participants 220 and 230 are provided with more “real estate” within the online meeting UI 200. That is, their visual expressions will be more readily detectable because their respective gallery-based tiles (e.g., the area of the UI that is displaying content related to them) emphasizes those individuals more than the expansive area-based tile 205A that is displaying the area view 205B. It is desirable, therefore, to provide the same level of exposure for the two participants in the area view 205B as the exposure that the online participants 220 and 230 are afforded.

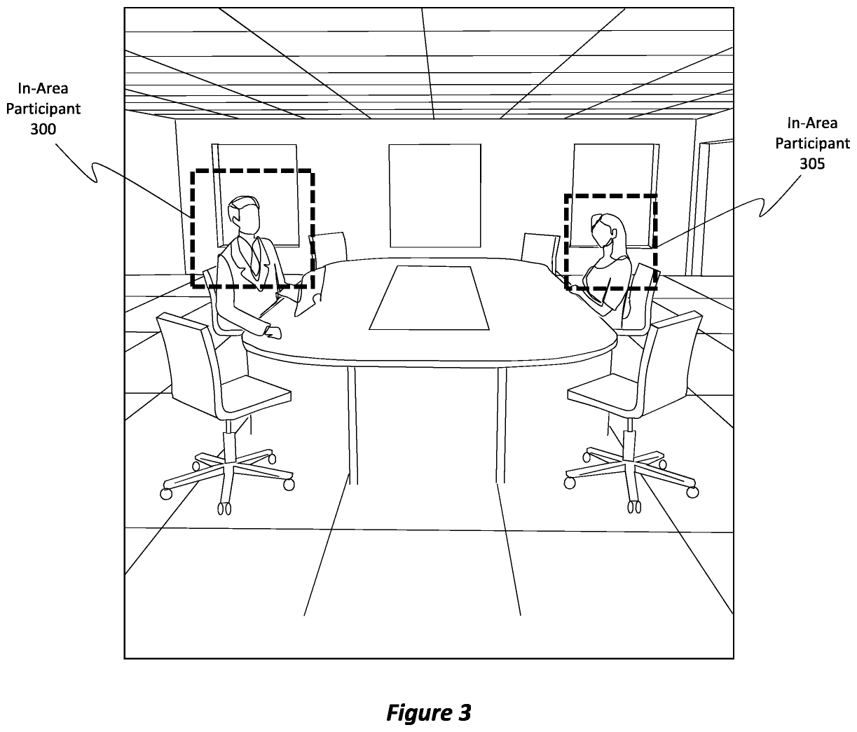

FIG. 3 shows a general scenario where the in-area participant 300 is identified and where the in-area participant 305 is identified. While this example scenario shows only two in-area participants, one will appreciate how the principles disclosed herein can be applied to any number of participants, without limit.

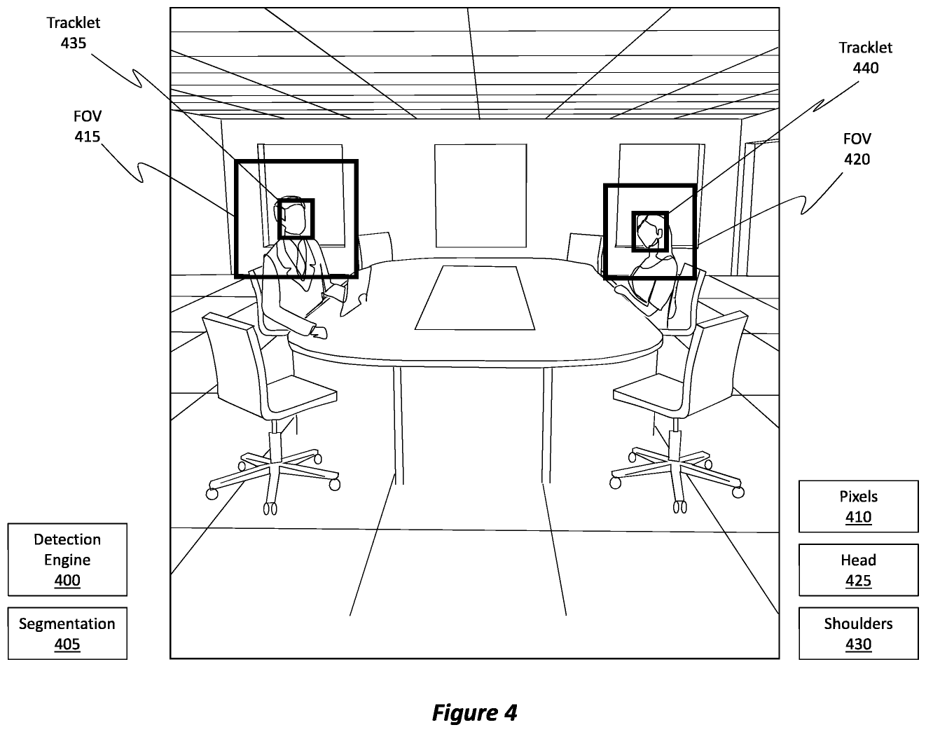

FIG. 4 shows the use of a detection engine 400. The detection engine 400 can optionally be any type of machine learning engine. As used herein, reference to any type of machine learning may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

The detection engine 400 performs image or object segmentation 405 on the video stream of the online meeting to identify pixels 410 that represent or that correspond to the in-area participants. That it, the detection engine 400 is able to segment the images in the stream to identify pixels that are representative of the in-area participants. Segmentation can occur via machine learning processes. Image segmentation includes the process of classifying specific pixels as corresponding to an identified type of object. For instance, pixels that represent a human will be identified and classified as corresponding to a human. Pixels that represent a desk will be identified and classified as such. In this regard, the pixels within an image can be classified and represented via one or more labels, masks, or other object characterization structure. The detection engine 400 also generates a field of view (FOV) around those in-area participants. For instance, FIG. 4 shows a FOV 415 that is generated around the man and a FOV 420 that is generated around the woman. After identifying the pixels representative of an in-area participant, the embodiments are able to generate a bounding structure that encompasses at least a selected portion of the pixels that are representative of the in-area participant. This bounding structure is the FOV. The size of the FOV is generally set so as to include the in-area participant's head 425 and shoulders 430.

In some cases, an additional tracklet is generated. In one embodiment, a tracklet is a bounding box generated using face recognition and tracking to recognize and track the heads of in-area participants who are located in the area. To illustrate, FIG. 4 shows a tracklet 435 around the man's head and a tracklet 440 around the woman's head. In some cases, the FOVs are set so that the tracklets are positioned in the middle of the FOV.

The shape and size of the FOVs can be set to any shape and size. For instance, the shape of a FOV can be a square, rectangular, any polygon, or any other geometric shape (e.g., circle, oval, etc.) without limit. Similarly, the shape of the tracklet can be set to any shape. In some cases, the shape of the tracklet is the same as that of the FOV. In some cases, the shape of the tracklet is different from that of the FOV. Generally, the size of the FOV, as mentioned previously, is set to include the participant's head and shoulders. Other sizes, however, can be used. In some cases, the size of the FOV is larger such that it includes more than the participant's head and shoulders. In some cases, the size of the FOV may be sufficient such that the FOV includes the participant's trunk. In some cases, the size of the FOV may be smaller and may be more focused on the participant's head. In any event, the detection engine 400 performs an image or video stream analysis to identify the in-area participant.

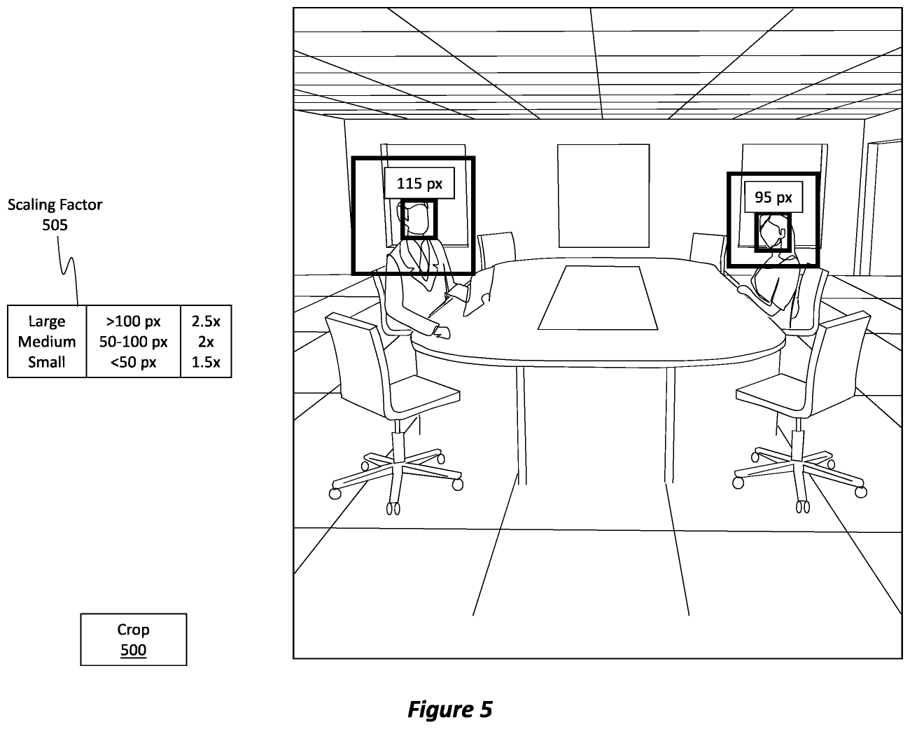

Having generated the FOVs for the in-area participants, the embodiments then crop the FOVs from the area view to generate respective gallery-based tiles for the various in-area participants. In some implementations, the embodiments apply scaling factors to the FOVs, as shown in FIG. 5.

FIG. 5 shows an example scenario where the tracklet for the man is shown as having 115 pixels. The tracklet for the woman is shown as having 95 pixels. The embodiments are able to selectively scale the FOV (including the tracklets) of these participants so that they can have an improved visualization in their respective gallery-based tiles in the gallery view. As mentioned previously, the embodiments crop 500 the FOV from the area view. A scaling factor 505 can then optionally be applied to the FOV.

The scaling factor 505 can vary depending on the size of the FOV and of the tracklet. FIG. 5 illustrates one example implementation of the scaling factor. One will appreciate, however, how other scaling factors can optionally be used.

If the pixel size of the tracklet is over 100 pixels, then the tracklet can be considered to be a “large” tracklet. If the pixel size of the tracklet is between 50 pixels and 100 pixels, then the tracklet can be considered a “medium” tracklet. If the pixel size of the tracklet is less than 50 pixels, then the tracklet can be considered a “small” tracklet.

The scaling factors are based on the categorization of the tracklet. In some cases, a large tracklet can be scaled by a factor of 2.5×. In some cases, a medium tracklet can be scaled by a factor of 2×. In some cases, a small tracklet can be scaled by a factor of 1.5×. One might presume that the smaller the tracklet, the larger the scaling factor; however, that is not typically the case. Due to the resolution (which is typically on the order of 1080p) of the video stream, if a small tracklet were to be scaled up a large amount, then the resulting visualization provided in a gallery-based tile will be low in quality because of its poor resolution. Thus, less up scaling will be used for smaller tracklets.

Accordingly, when a video stream has a resolution of about 1080p, it can be difficult to digitally zoom in on small faces. Thus, the embodiments consider the pixel size of a participant's tracklet when determining when and how to impose a scaling effect. This scaling effect can be a dynamic scaling effect that is based on an input resolution of the tracklet.

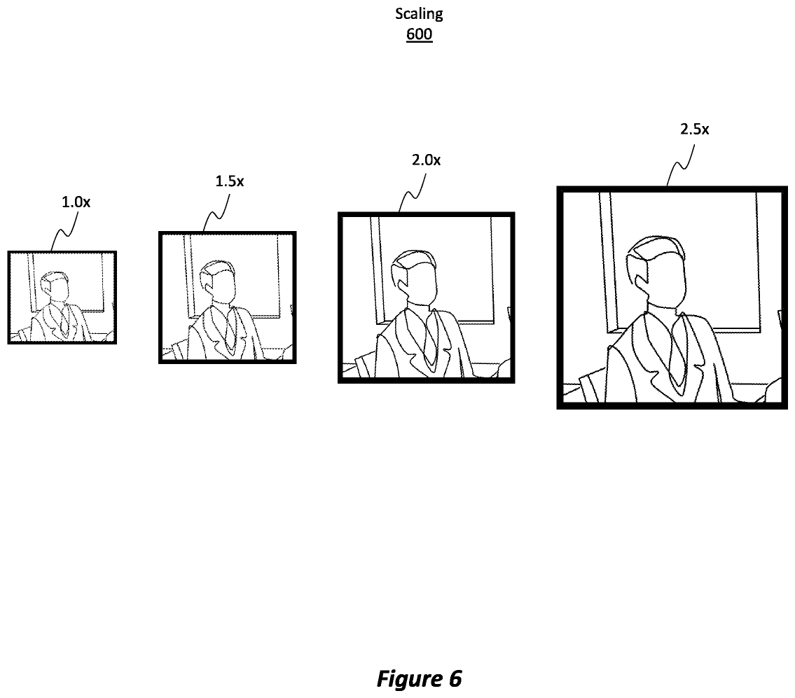

FIG. 6 shows the scaling 600 of the FOV and tracklets. Here, a FOV is shown as having a 1.0× scaling factor imposed on it, a 1.5×, a 2.0×, and a 2.5×.

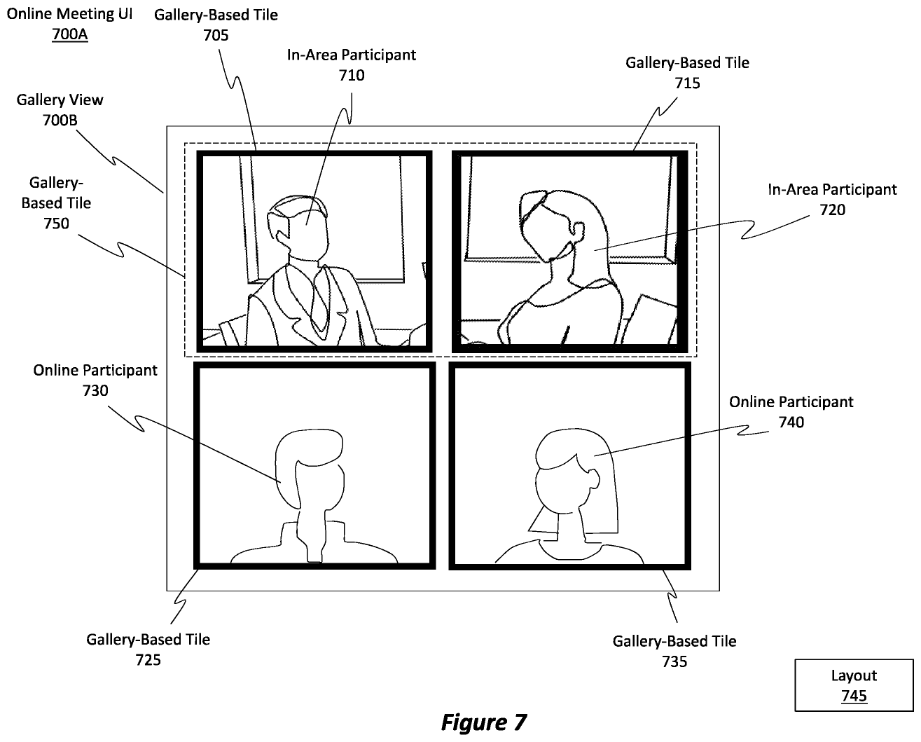

FIG. 7 now shows an updated version of the online meeting UI 700A, which is an updated version of the online meeting UI 200 of FIG. 2. Whereas the UI 200 of FIG. 2 shows the area view 205B, the UI 700A of FIG. 7 is now showing only a gallery view 700B that is visually displaying gallery-based tiles of the various participants.

The UI 700A is shown as displaying a gallery-based tile 705 for the in-area participant 710, who is representative of the in-area participant 300 of FIG. 3. The UI 700A is also displaying a gallery-based tile 715 for the in-area participant 720, who is representative of the in-area participant 305 from FIG. 3. The UI 700A is displaying the gallery-based tile 725 for the online participant 730 and the gallery-based tile 735 for the online participant 740, who are representative of the online participants 220 and 230 from FIG. 2, respectively.

Some embodiments organize or structure the UI 700A in a manner to have a particular layout 745 that generally mimics or perhaps corresponds to the physical positioning of the in-area participants within the area. As an example, the in-area participant 710 is generally located on the left-hand side of the area, as shown in FIG. 3. The in-area participant 720 is generally located on the right-hand side of the area, as shown in FIG. 3. Based on the actual, physical locations of the in-area participants, the embodiments caused the gallery-based tile 705 of the in-area participant 710 to be on the left-hand side of the UI 700A and caused the gallery-based tile 715 of the in-area participant 720 to be on the right-hand side of the UI 700A. Thus, the actual, real-world locations of the in-area participants can be used to influence the layout of the UI 700A, particularly with regard to placement locations of the gallery-based tiles in the gallery view 700B.

Recall, the gallery-based tiles 705 and 715 were generated by cropping, extracting, or otherwise parsing content from the data stream of the area view. In some implementations, those gallery-based tiles can be merged into a single data stream and a single tile, as shown by tile 750, though they may have the appearance of being different gallery-based tiles in the gallery. This single tile 750 (data stream) can then replace the data stream of the original area view data stream. The dashed line labeled tile 750 represents a single tile, though it appears as if multiple tiles (e.g., gallery-based tiles 705 and 715) are present.

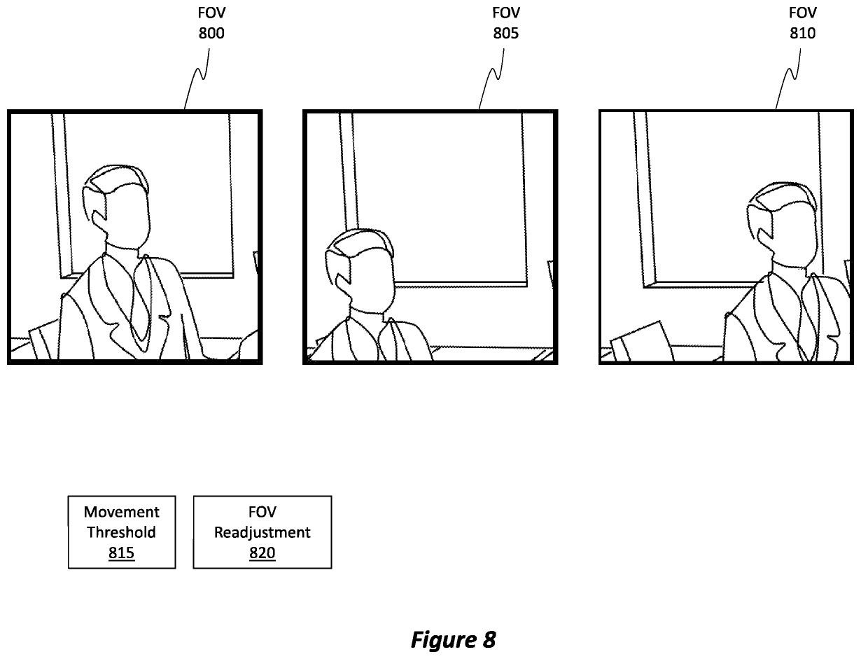

FIG. 8 shows three different FOVs, namely, FOV 800, 805, and 810. Notice, the positioning of the in-area participant within the FOVs is slightly different. The embodiments can detect the movement of the in-area participant. If that movement is below a movement threshold 815, then the FOV will generally remain at the same location, despite the movements of the in-area participant. To illustrate, notice how the FOV 800, 805, and 810 are all generally aimed at the same location (e.g., generally capturing the window well in the background) despite the in-area participant shifting position (e.g., in FOV 800, the in-area participant is generally in the middle of the FOV, in FOV 805, the in-area participant is to the left-hand side, in FOV 810, the in-area participant is to the right-hand side). If the movement of the in-area participant is less than the movement threshold 815, then the FOV can remain the same.

On the other hand, if the movement of the in-area participant exceeds the movement threshold 815 but is less than a second threshold, then the embodiments are able to reposition the FOV so that the in-area participant is again generally in the center of the FOV. Such a process is a FOV readjustment 820. As a result, the embodiments can be tasked with keeping a tile as stable as possible.

On the other hand, if the movement of the in-area participant exceeds the second threshold, then some embodiments will transition from displaying the gallery view to again displaying the area view until such time as the participant's detected movement settles (i.e. is less than at least the second threshold). Thus, different events can act as triggering points for transitioning back and forth between displaying the area view and displaying the gallery view.

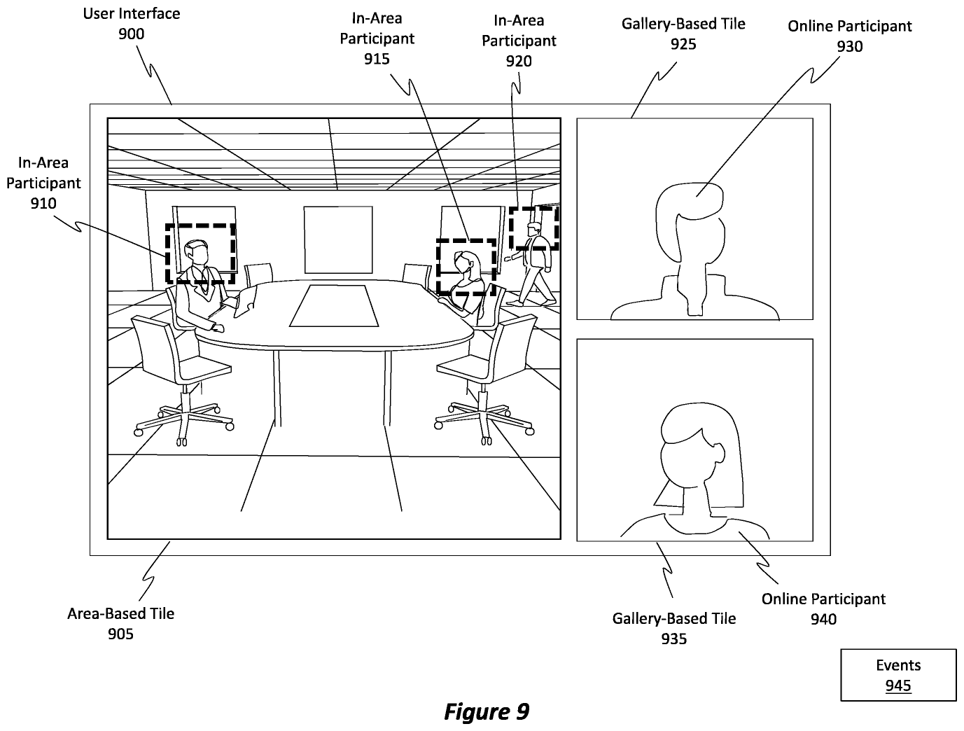

For instance, at a first point in time, the embodiments may display the area view. If the detected movements of the in-area participants are less than a selected movement threshold, then the embodiments can be triggered to generate the gallery view and thus display the gallery-based tiles of the in-area participants in lieu of displaying the expansive area view. If, while displaying the gallery view, another event occurs, then the embodiments may be triggered to stop displaying the gallery view and instead transition to displaying the area view. An example of such an event is when an in-area participant has a level of movement that exceeds the threshold mentioned above. Another example of such an event is when a new in-area participant enters the area. When a new participant enters the area, the embodiments can detect the emergence of this participant and can trigger the display of the area view. Such a scenario is shown in FIG. 9.

Previously, the embodiments were displaying the UI 700A of FIG. 7, where this UI 700A displayed a gallery view comprising the various different gallery-based tiles of the participants. In FIG. 9, the embodiments detected the new presence of a new participant in the area. As a result, the user interface 900 is triggered to transition from displaying the gallery view to now displaying an area-based tile 905 that comprises the area view.

The area-based tile 905 shows the in-area participant 910 and the in-area participant 915. Additionally, a new participant (e.g., in-area participant 920) is shown entering the area captured by the area-based tile 905. The embodiments have detected the presence of this new participant (e.g., perhaps via a machine learning engine analyzing the video stream content) and triggered the display of the area-based tile 905 instead of the previous gallery view.

In addition to the area-based tile 905, the UI 900 is continuing to display the gallery-based tile 925 of the online participant 930 and the gallery-based tile 935 of the online participant 940. The embodiments are able to selectively transition from displaying the area-based tile comprising the area view to respective gallery-based tiles and from displaying the gallery-based tiles back to the area-based tile comprising the area view based on the occurrence of various events 945. As mentioned previously, the events 945 can include the emergence or perhaps the exit of an in-area participant. The events 945 can also include a scenario where one or more of the in-area participants are moving, and where a level of that movement exceeds a defined threshold. In more general terms, the events 945 are tied to movements of the in-area participants exceeding a predefined threshold. Those in-area participants can be participants who are already in the area or scene, participants who are newly entering the area, or even participants who are leaving the area.

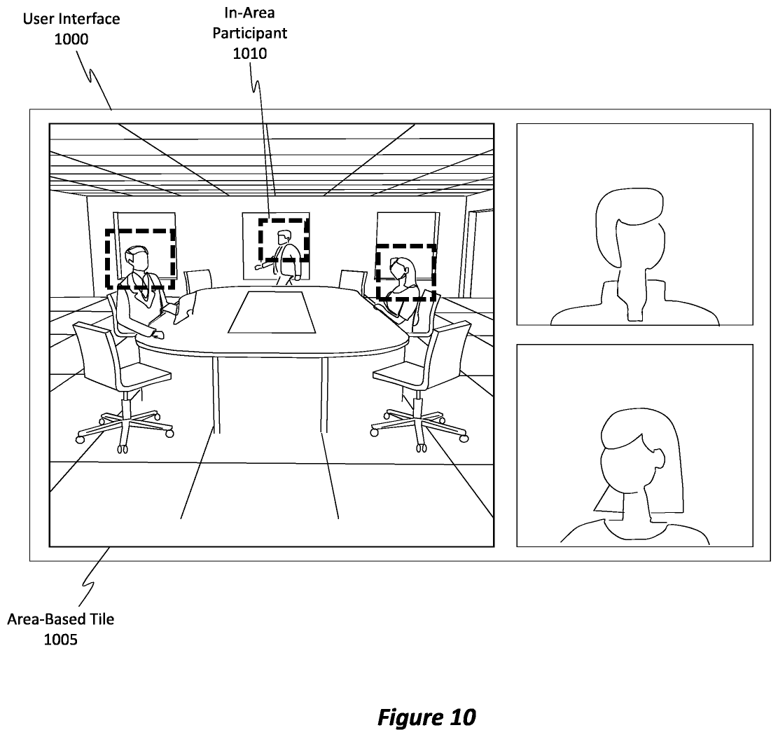

FIG. 10 shows how the UI 1000 is continuing to display the area-based tile 1005 because the in-area participant 1010 is still moving, and that movement is exceeding the permitted movement threshold.

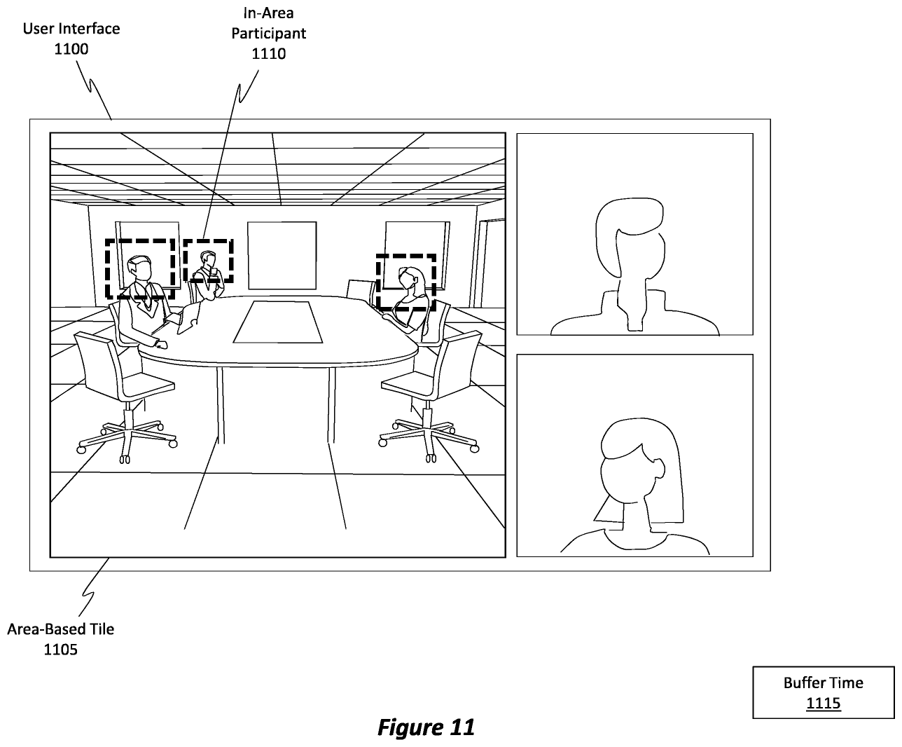

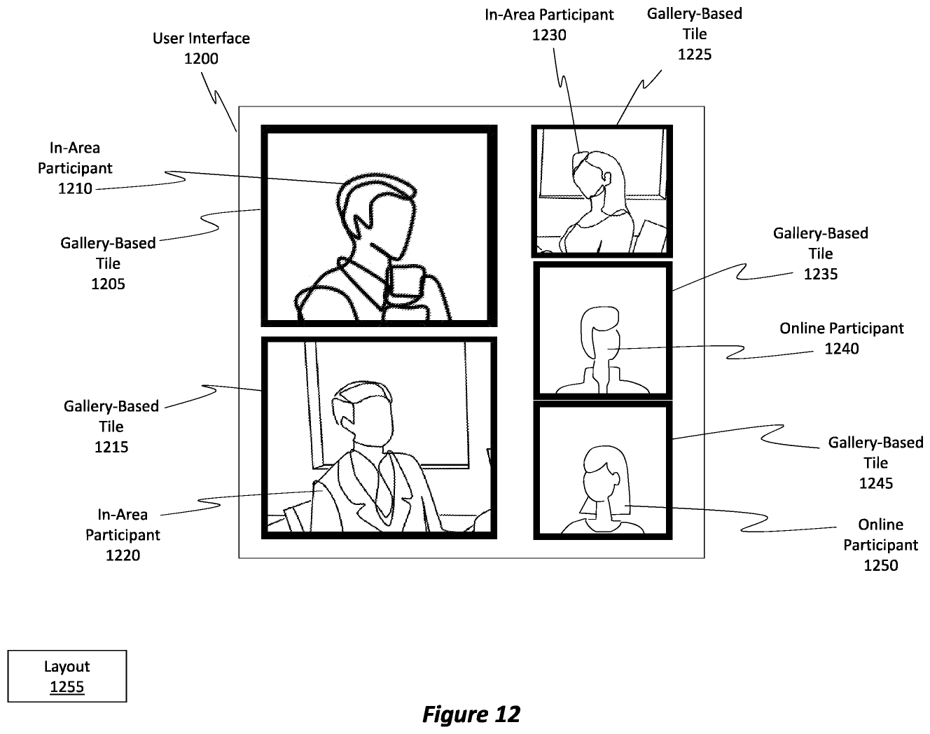

FIG. 11 shows how the UI 1100 is still displaying the area-based tile 1105 even though the in-area participant 1110 is now seated. Some embodiments may delay the transition from the area view to the gallery view until such time as a buffer time 1115 is satisfied. This delay is beneficial because transitioning from the area view to the gallery view can be somewhat jarring to users, and the buffer time 1115 adds a delay into the transition in an effort to prevent frequent transitions from occurring so as to minimize the level of jarring participants may experience when viewing the UI 1100. The buffer time 1115 can be set to any time period. Examples of such time periods can include, but certainly are not limited to, 1 second (s), 2 s, 3 s, 4 s, 5 s, or more than 5 s. Thus, it may be the case that the in-area participant 1110 will need to be generally stationary for the buffer time 1115 before the embodiments transition to displaying the gallery view for the in-area participants. FIG. 12 is illustrative.

FIG. 12 shows a user interface 1200, which is an updated version of the UI 1100 from FIG. 11. Whereas the UI 1100 showed the area-based tile 1105, the embodiments have caused the UI to transition to now display a gallery view comprising gallery-based tiles of the in-area participants.

To illustrate, the gallery-based tile 1205 is showing the in-area participant 1210, who is representative of the in-area participant 1110 from FIG. 11. The gallery-based tile 1215 is showing the in-area participant 1220, and the gallery-based tile 1225 is showing the in-area participant 1230. The UI 1200 is also showing the gallery-based tile 1235 of the online participant 1240 and the gallery-based tile 1245 of the online participant 1250.

Notice the layout 1255 of the UI 1200. The in-area participants 1210 and 1220 were generally seated on the left-hand side of the area shown in FIG. 11. The in-area participant 1230 was generally seated on the right-hand side of the area shown in FIG. 11. The embodiments structured the gallery-based tiles of the UI 1200 to generally correspond to the physical positioning of the in-area participants in the area. For instance, the gallery-based tiles 1205 and 1215 are on the left-hand side of the UI 1200 while the gallery-based tile 1225 is on the right-hand side of the UI 1200. Thus, the layout 1255 of the gallery view comprising the gallery-based tiles can generally be dependent on the actual physical locations of the in-area participants within the area.

### Merged Tiles

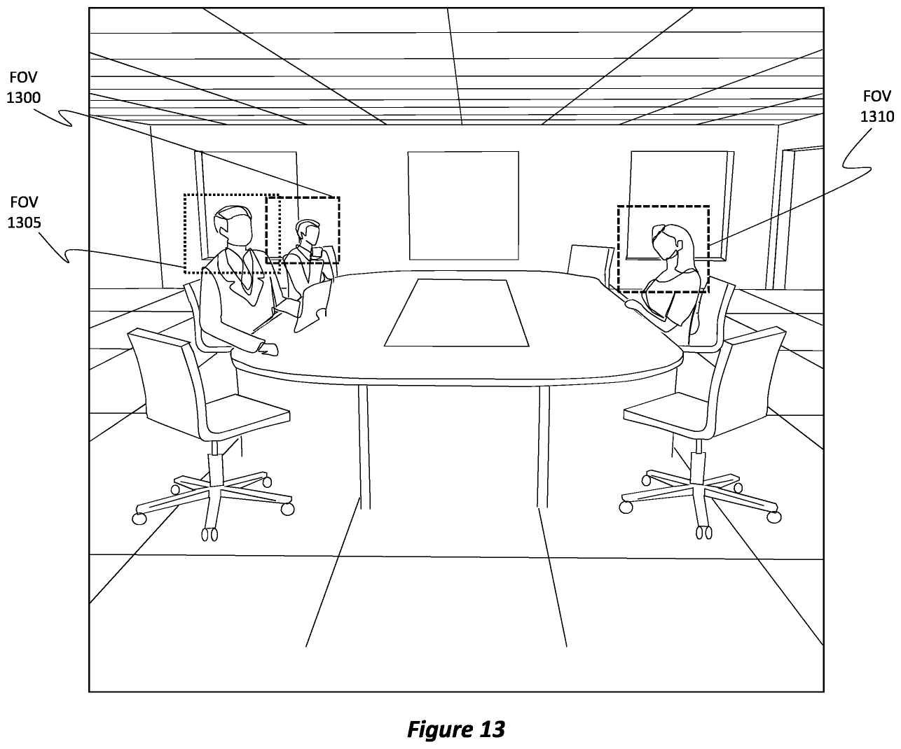

FIG. 13 shows an example scenario illustrating multiple FOVs. These FOVs include FOV 1300, 1305 and 1310.

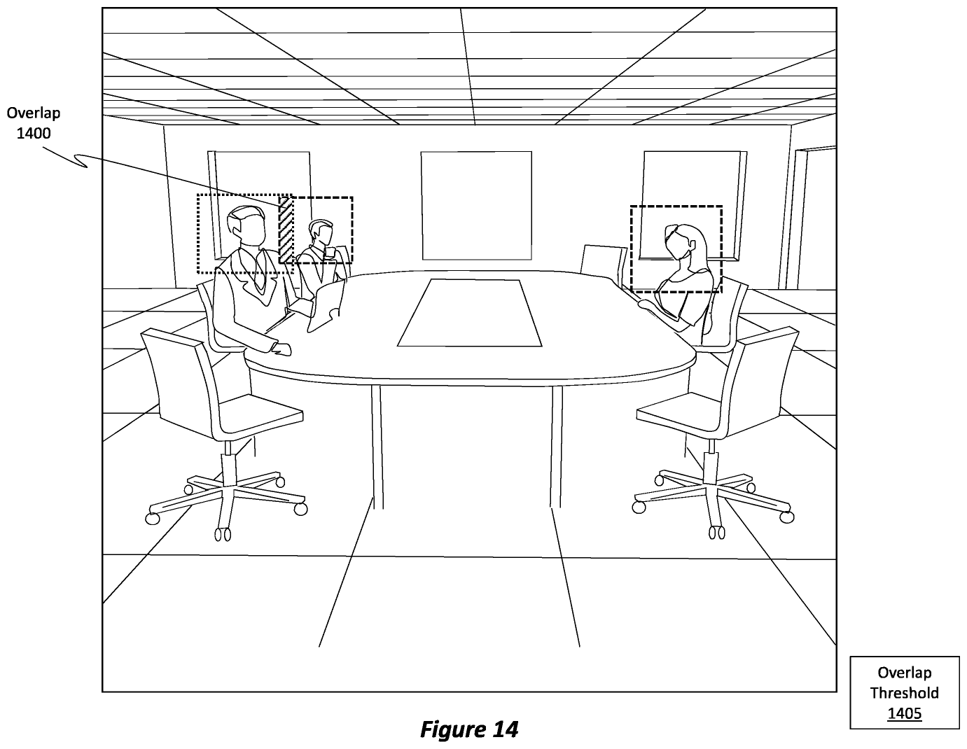

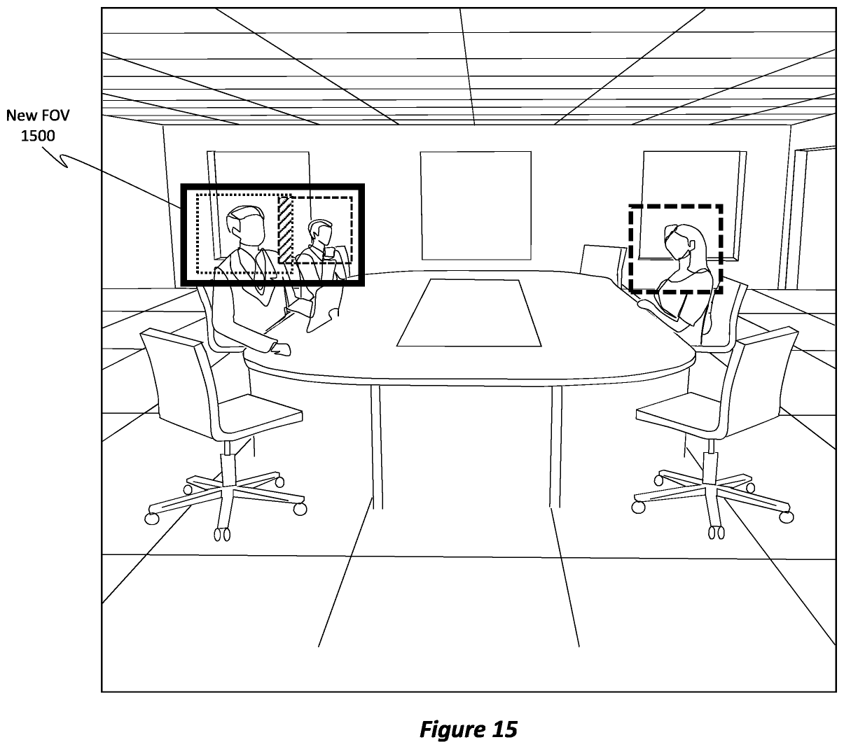

FIG. 14 shows how there is a partial overlap 1400 between the FOVs 1300 and 1305. The embodiments are able to monitor the level of overlap that might exist between two or more FOVs. If the level of overlap exceeds a permitted overlap threshold 1405, then the embodiments can trigger the generation of a new FOV, as shown in FIG. 15.

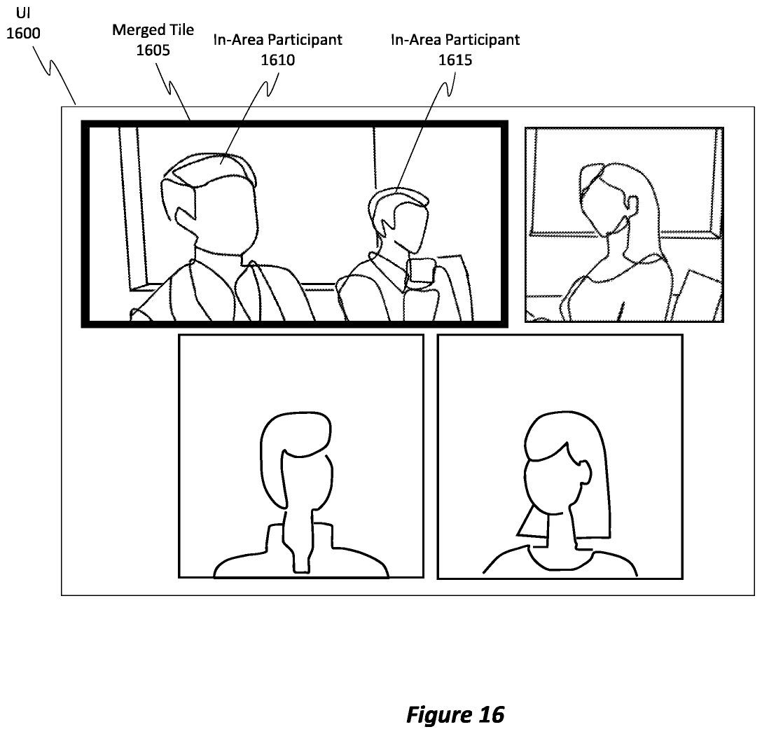

FIG. 15 shows a new FOV 1500 that includes or encompasses both of the FOVs 1300 and 1305 from FIG. 13. This new FOV 1500 was generated because the level of overlap 1400 from FIG. 14 exceeded a predefined threshold. With this new FOV 1500, the embodiments are now able to generated a merged gallery-based tile, as shown in FIG. 16. Portions of this disclosure use the phrase “merged tile.” One will appreciate how a “merged tile” is still considered a gallery-based tile because the emphasis of the FOV is still focused on individual participants whereas there is no specific emphasis or directional focus with regard to an area-based tile. Recall, a merged tile is generated from the combination of at least two different FOVs. A FOV is selected to focus on a participant's head and shoulders. Thus, the focus of the FOV is directed to the participant, where “focus” is linked to a scenario where at least a selected percentage or perhaps number of the pixels are related to the participant as opposed to being related to background content. Two different FOVs can be combined to generate the merged tile. In this sense, a merged tile can have two (or more) primary points of focus, which are the heads and shoulders of the participants. Thus, at least a selected percentage or perhaps number of pixels are related to the participants as opposed to be related to the background. In contrast, the area-based tile does not have a similar focus point; instead, the purpose and emphasis of the area-based tile is to expansively cover an entire area.

FIG. 16 shows a UI 1600 that is now displaying a merged tile 1605, which is also a gallery-based tile. This merged tile 1605 shows a combination of both the in-area participant 1610 and the in-area participant 1615. The other gallery-based tiles in the gallery view are also illustrated.

From this figure, one can appreciate how if two or more in-area participants are positioned too proximately to one another (e.g., as based on the level of overlap between their respective FOVs), then it is beneficial to include those two or more in-area participants in the same gallery-based tile. The metric for determining whether two or more in-area participants will be included in the same gallery-based tile is based on the level or amount of overlap that might exists between their corresponding FOVs.

FIG. 16 also shows how the border around the merged tile 1605 is bolded or otherwise emphasized (e.g., perhaps a different line style, color, visual effect such as flashing, etc.) as compared to the other gallery-based tiles. The embodiments are able to detect an active speaker in the online meeting. The embodiments are also able to identify a tile (area-based tile or gallery-based tile) that is associated with the active speaker. The embodiments can then visually emphasize the tile that is associated with the active speaker. If the active speaker is included in a merged tile, as is shown in FIG. 16, then the merged tile can be visually emphasized.

As mentioned above, it is sometimes the case that faces or body parts overlap one another, resulting in occlusion. For instance, if people sit very close to each other, then the process of separating those individuals into their own respective gallery-based tiles can be quite challenging. To compensate for such challenges, the embodiments are able to employ intelligence in determining when to merge the FOVs of participants.

### Template Based FOVs

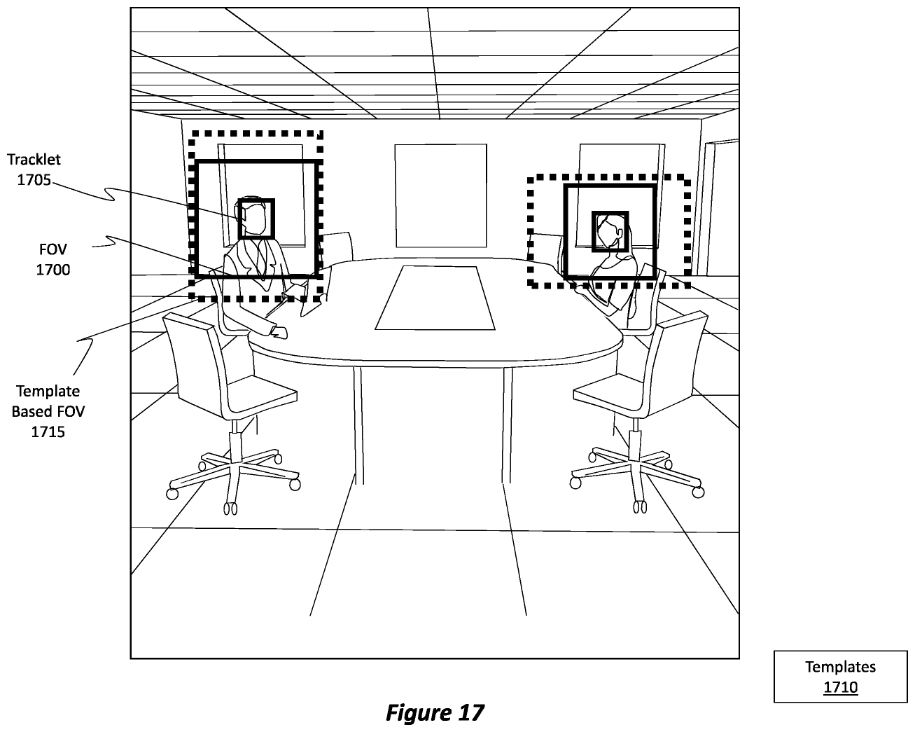

Some embodiments structure a FOV based on a predefined template size for a FOV. For instance, some online meeting platforms might have existing tile templates for video streams. The embodiments are able to dynamically modify or structure a FOV to correspond to these preexisting templates. FIGS. 17 through 19C are illustrative.

FIG. 17 shows an example scenario illustrating a FOV 1700 and a tracklet 1705 that was generated for an in-area participant. The embodiments are able to access a set of predefined templates 1710 that an online meeting platform may have. The embodiments can then generate a template based FOV 1715 based on the identified templates 1710. The embodiments can also modify the FOV 1700 to mimic or match the template based FOV 1715. In some cases, the positioning of the template based FOV 1715 can be set so that the tracklet 1705 of the participant's face is generally in the center of the template based FOV 1715.

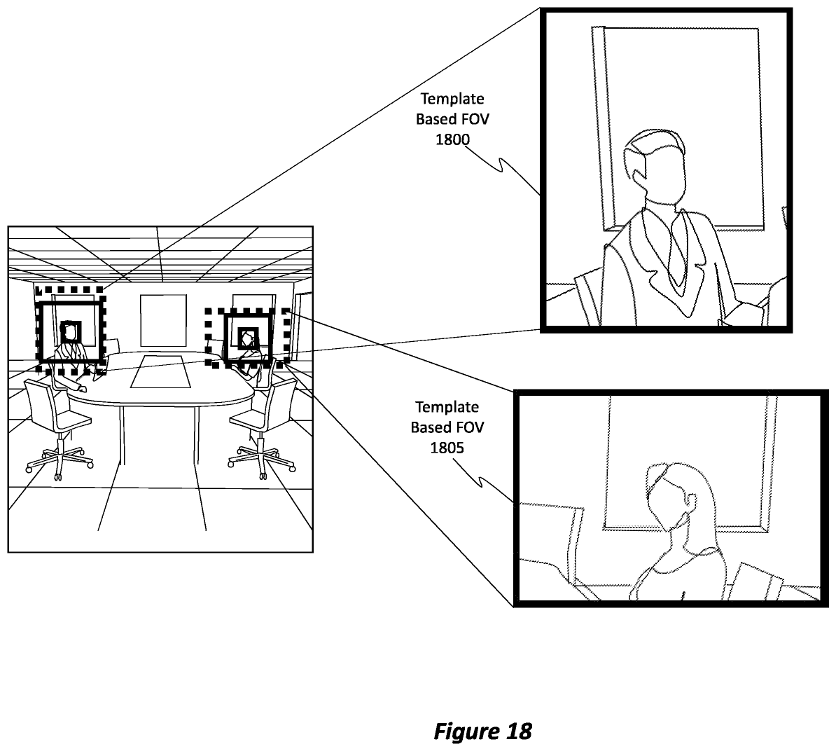

FIG. 18 shows the corresponding gallery-based tiles, which are based on the template based FOV. For instance, a first gallery-based tile of the man is shown as being dependent on the template based FOV 1800, which is representative of the template based FOV 1715 of FIG. 17. Relatedly, a second gallery-based tile of the woman is shown as being dependent on the template based FOV 1805.

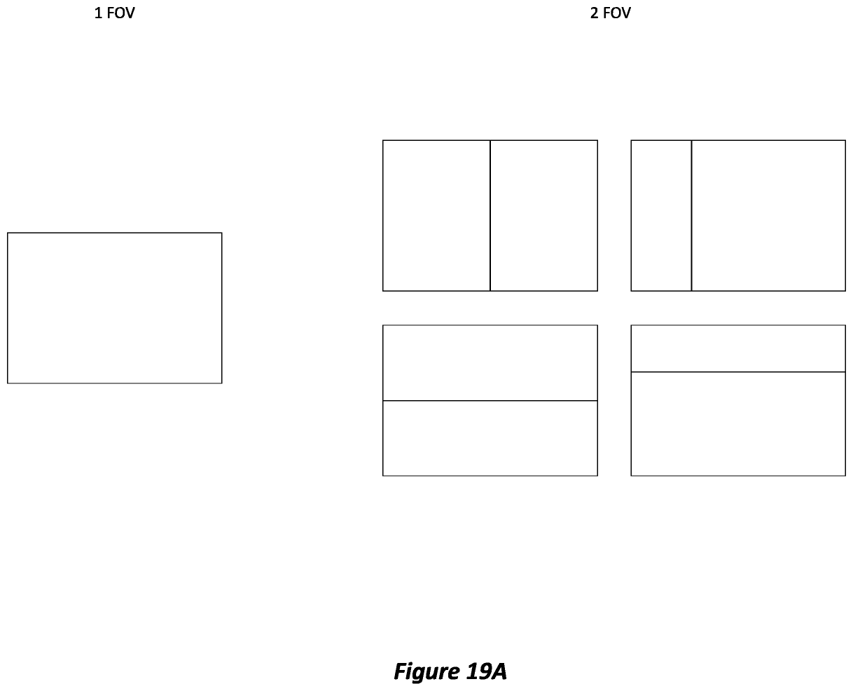

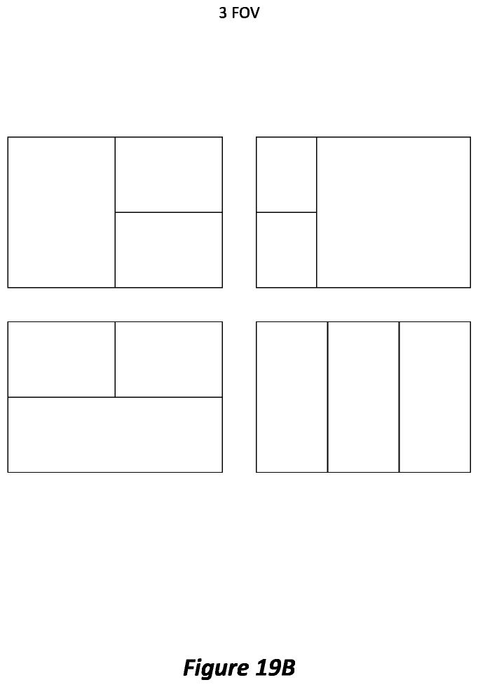

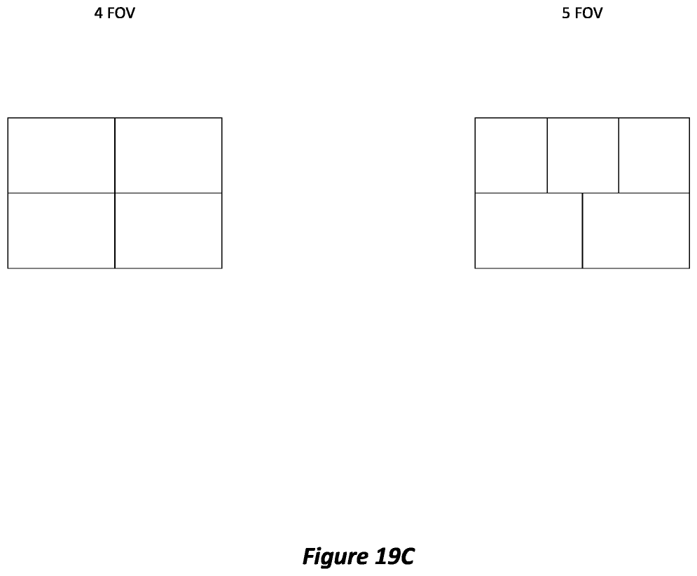

Any number and different types of template based FOVs can be used. FIGS. 19A, 19B, and 19C illustrate a few non-limiting examples of templates. FIG. 19A shows an example template for a UI that includes a single FOV. FIG. 19A also shows various examples of a UI that includes 2 FOVs.

FIG. 19B shows various example templates for a UI that includes 3 FOVs. FIG. 19C shows various example templates for UIs that include 4 FOVs and 5 FOVs. Of course, these are examples of templates, and other sized and configured templates can be used.

Accordingly, some embodiments employ template based FOVs that can optionally include additional pixels as part of an adjustment of FOVs to a selected tile template. In some cases, dynamic template based FOVs (e.g., a FOV that includes additional pixels to fit a selected template) are used, where the sizes of these FOVs can be dynamic and can vary between different modes or views.

Some principles disclosed herein can be artificial intelligence (AI) driven. For instance, the operations of obtaining the initial FOVs and the max scale FOVs can be driven by AI. The process of merging the overlapping FOVs based on “leakage” (aka overlap) can also be AI driven.

Some principles are driven based on the user experience (UX) and user interaction. For instance, the process of select the best template based on the number of FOVs and sizes can be driven by the user experience. The process of prioritizing FOVs and even the placement of FOVs in tiles can be driven by the UX.

The embodiments are beneficially able to centralize and normalize a participant's face within a gallery-based tile. The embodiments are also able to beneficially fill the gallery-based tiles with updated FOV results. Optionally, the embodiments can fall back to the room view if the gallery-based tiles cannot be sufficiently filled.

As mentioned previously, some embodiments select a FOV template based on the detected positioning of in-area participants within the area. For instance, different sized FOVs can be used based on the physical location of an in-area participant or based on the relative positioning of one participant relative to another participant. The template FOVs can be selected in a manner so as to preserve the seating arrangement and positioning of the in-area participants.

### Blurring Effects

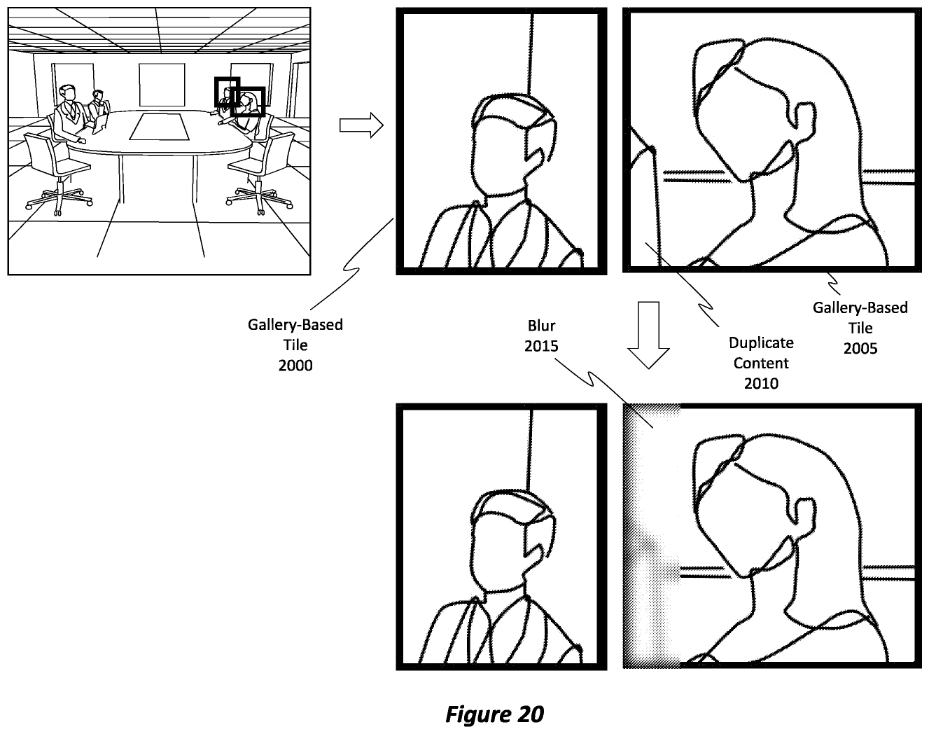

FIG. 20 shows a scenario showing a first gallery-based tile 2000 and a second gallery-based tile 2005. Notice, there is some duplicate content 2010 as between these two gallery-based tiles. In particular, the man's shoulder is shown in the gallery-based tile 2000 and in the gallery-based tile 2005. Some embodiments are able to selectively impose a blurring effect on the duplicate content, as shown by the blur 2015. Notably, the blurring is imposed on the gallery-based tile for which the duplicate content is not a primary portion of. For instance, the man's shoulder is the content that is duplicated or that is visualized in both gallery-based tiles. Inasmuch as the shoulder belongs or is associated with the man, the embodiments refrain from blurring the man's shoulder in his own gallery-based tile. On the other hand, the woman is the center of focus or the primary point of focus in the gallery-based tile 2005. Because the man is not the primary point of focus in the gallery-based tile 2005, the man's shoulder can be selectively blurred in the gallery-based tile 2005 to avoid calling attention to content that is not associated with the woman. Thus, the embodiments are able to selectively blur content that is not associated with the primary figure or participant in a participant's gallery-based tile.

Some embodiments blur only the specific content, such as the man's shoulder. Some embodiments blur out and entire strip of the gallery-based tile, where that strip includes the man's shoulder. For instance, in some cases, only the man's shoulder will be blurred, but the content above the man's shoulder will not be blurred. In some cases, a strip of the gallery-based tile will be blurred, as shown by the blur 2015. That is, in this situation, not only will the man's shoulder be blurred but also the pixels that are within the defined strip that includes the man's shoulder will be blurred.

### Example Methods

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

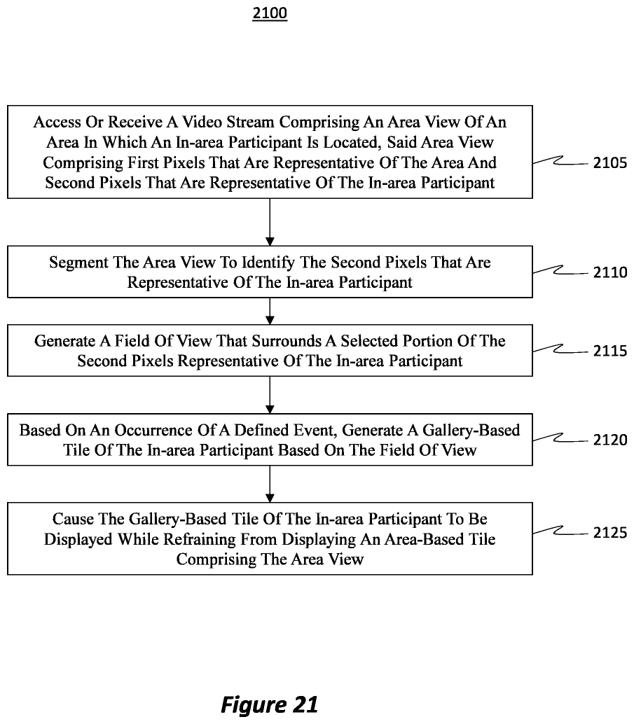

Attention will now be directed to FIG. 21, which illustrates a flowchart of an example method 2100 for generating a gallery-based tile of one or more in-area participants who are participating in an online meeting. Method 2100 can be implemented using any of the techniques and any of the UIs mentioned herein.

Method 2100 includes an act (act 2105) of accessing a video stream (e.g., video stream 105 from FIG. 1) comprising an area view (e.g., area view 115 of FIG. 1) of an area (e.g., area 110) in which an in-area participant (e.g., in-area participant 300 of FIG. 3) is located. This area view comprises first pixels (e.g., pixels 120) that are representative of the area and second pixels (e.g., pixels 120) that are representative of the in-area participant. In some cases, a front, room-facing camera generates the video stream.

Act 2110 includes segmenting the area view to identify the second pixels that are representative of the in-area participant. This segmenting process can optionally be performed via machine learning.

Act 2115 includes generating a field of view (e.g., FOV 415 from FIG. 4) that surrounds a selected portion of the second pixels representative of the in-area participant. It is often, though not necessary, that the FOV encompasses the participant's head and shoulders. In some implementations, the FOV additionally includes some pixels from the first set of pixels, such as pixels that are representative of the background area relative to the in-area participant. In some implementations, the FOV filters or omits the pixels from the first set of pixels and retains only the pixels that are representative of the in-area participant. In such a scenario, the embodiments can optionally replace the filtered pixels with alternative pixels representative of a different background image or, alternatively, can provide a white (or other selected color) background for the in-area participant. Accordingly, in some embodiments, the FOV additionally includes a selected portion of the first pixels, such as pixels that represent background content behind the in-area participant.

Based on an occurrence of a defined event, act 2120 includes generating a gallery-based tile of the in-area participant by cropping the field of view from the area view. In some implementations, various scaling factors or dynamic scaling effects can be imposed on the FOV after it is cropped, where that dynamic scaling effect can be based on an input resolution of the tracklet or perhaps of the FOV. That is, the process of generating the gallery-based tile can optionally further include imposing a scaling factor on the cropped field of view. The amount of scaling can be dependent on the pixel size of a tracklet that is associated with the field of view. Tracklets that have a relatively higher number of pixels can optionally be scaled more while tracklets that have a relatively lower number of pixels can optionally be scaled less.

The defined event can include a scenario where the amount of movement of the in-area participants is below a certain threshold. That is, if the participants are generally stationary (as in their movement is less than the movement threshold), then the embodiments can trigger the generation of the gallery-based tile(s). On the other hand, if their movements exceed the threshold, then the embodiments may refrain from generating the gallery-based tile(s) until such time as the participants' movements have settled and are below the threshold. This, this “defined event” can optionally be an event where the level of movement is low such that it is below the threshold.

Act 2125 includes causing the gallery-based tile of the in-area participant to be displayed while refraining from displaying the area-based tile comprising the area view. The gallery-based tile of the in-area participant can be displayed simultaneously with one or more gallery-based tiles of one or more online participants that are located remotely relative to the area. Additionally, as mentioned throughout, the gallery-based tile of the in-area participant includes pixels representative of a head of the in-area participant and pixels representative of shoulders of the in-area participant.

FIG. 7 shows how the UI 700A is displaying the gallery-based tile but is not displaying the area-based tile comprising the area view. Thus, the embodiments have been triggered (e.g., based on the lack of movement of the participants) to generate and display the various gallery-based tiles. Stated differently, the defined event can optionally be based on a detected movement of the in-area participant(s) being under a movement threshold.

In some cases, the method may further include an act of transitioning from displaying the gallery of the gallery-based tiles back to displaying the area-based tile comprising the area view. This transitioning can optionally be based on the occurrence of a second event. As an example, this second event can include a scenario where the participants are now moving, and that movement exceeds the movement threshold. In some cases, the second event can include the emergence or the exiting of a participant, such that that participant's movement triggered the embodiments to display the area view instead of the gallery view (which includes the gallery-based tiles).

In some cases, the method may include additional acts. For instance, one additional act can include segmenting the area view to identify third pixels that are representative of a second in-area participant located in the area. Another act can include generating (e.g., perhaps within the area view) a second field of view that surrounds a selected portion of the third pixels (e.g., the participant's head and shoulders). Based on the defined event (e.g., any movements being less than the movement threshold), another act can include generating a second gallery-based tile of the second participant by cropping, extracting, parsing, or otherwise obtaining the second field of view from the area view. Yet another act can include causing the second gallery-based tile of the second in-area participant to be displayed simultaneously with the gallery-based tile of the in-area participant while refraining from displaying the area view. FIG. 7 is representative of such processes. Furthermore, the above acts can be performed in parallel with the acts mentioned previously.

In some implementations, the method can further include detecting an occurrence of a second defined event. For example, this event can include a detected movement exceeding a predefined threshold. Optionally, the movement can be from a participant who is already in the area or the movement can be from a participant who is newly entering the area.

In response to the occurrence of the second defined event, the method can include transitioning from displaying the gallery view (which includes the first and second gallery-based tiles) to displaying the area view. That is, the gallery-based tiles of the in-area participants are no longer displayed once the area view is displayed.

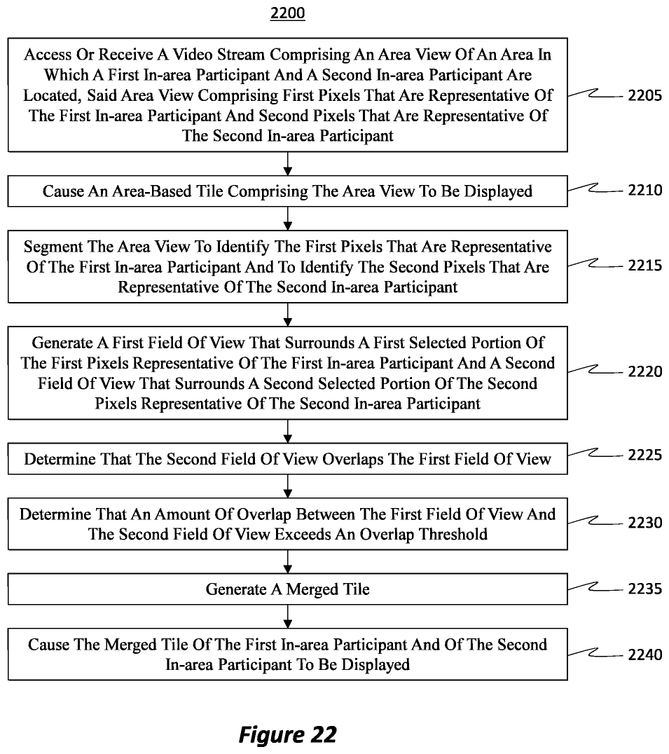

FIG. 22 shows a flowchart of an example method 2200 for generating a gallery-based tile of one or more in-area participants who are participating in an online meeting. Act 2205 includes accessing a video stream comprising an area view of an area in which a first in-area participant and a second in-area participant are located. This area view comprises first pixels that are representative of the first in-area participant and second pixels that are representative of the second in-area participant. Act 2210 includes causing the area view to be displayed.

In act 2215, the embodiments segment the area view to identify the first pixels that are representative of the first in-area participant and to identify the second pixels that are representative of the second in-area participant.

Act 2220 includes generating a first field of view (e.g., FOV 1300 from FIG. 13) that surrounds a first selected portion of the first pixels representative of the first in-area participant and a second field of view (e.g., FOV 1305) that surrounds a second selected portion of the second pixels representative of the second in-area participant. Act 2225 includes determining that the second field of view overlaps the first field of view. For instance, FIG. 14 shows an overlap 1400 between the two different FOVs.

Act 2230 includes determining that an amount of overlap between the first field of view and the second field of view exceeds an overlap threshold (e.g., overlap threshold 1405).

Act 2235 includes generating a merged tile (e.g., merged tile 1605 of FIG. 16) by cropping a third field of view (e.g., new FOV 1500 from FIG. 15) from the area view. This third field of view comprises a combination of the first field of view and the second field of view. In some cases, the third field of view may be larger than the combination of the first and second fields of view.

Act 2240 includes causing the merged tile of the first in-area participant and of the second in-area participant to be displayed while refraining from displaying the area view. Optionally, the merged tile can be displayed simultaneously with a second tile of a third in-area participant. A layout by which the merged tile and the second gallery-based tile are displayed can optionally correspond to physical locations of the first, second, and third in-area participants within the area. As before, the merged tile and the second gallery-based tile can be displayed simultaneously with one or more gallery-based tiles of one or more online participants.

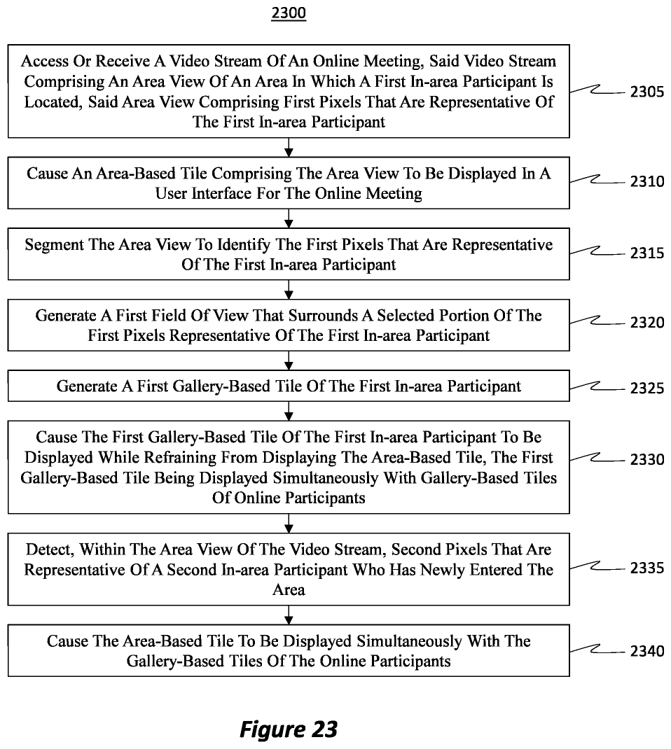

FIG. 23 shows a flowchart of an example method 2300 for transitioning between an area view and a gallery view that includes one or more gallery-based tiles of one or more in-area participants who are participating in an online meeting. Optionally, any of the disclosed methods and operations can be performed by a cloud service. Act 2305 includes accessing a video stream of an online meeting. This video stream comprises an area view of an area in which a first in-area participant is located. The area view comprises first pixels that are representative of the first in-area participant.

Act 2310 includes causing the area view to be displayed in a user interface for the online meeting. Act 2315 includes segmenting the area view to identify the first pixels that are representative of the first in-area participant.

The embodiments generate (in act 2320) a first field of view that surrounds a selected portion of the first pixels representative of the first in-area participant. Act 2325 includes generating a first gallery-based tile of the first in-area participant by cropping the first field of view from the area view. In some implementations, the fields of view are based on a template associated with the online meeting.

Act 2330 includes causing the first gallery-based tile of the first in-area participant to be displayed (e.g., within a gallery view) while refraining from displaying the area view. The first gallery-based tile is displayed simultaneously with one or more gallery-based tiles of online participants.

Act 2335 includes detecting, within the area view of the video stream, second pixels that are representative of a second in-area participant who has newly entered the area. Based on this detection event, the embodiments cause (in act 2340) the area view to be displayed simultaneously with the one or more gallery-based tiles of the online participants while refraining from displaying the first gallery-based tile.

In some implementations the method can further include generating a second field of view that surrounds a selected portion of the second pixels that are representative of the second in-area participant. The embodiments can also determine that a movement of the second in-area participant is below a movement threshold. In response to determining that the movement of the second in-area participant is below the movement threshold, the embodiments generate a second gallery-based tile of the second in-area participant by cropping the second field of view from the area view. The first and second gallery-based tiles are then displayed. The embodiments also cause the one or more gallery-based tiles of the online participants to be displayed. The embodiments also refrain from displaying the area view.

In some cases, content from the first gallery-based tile is also included in the second gallery-based tile. For instance, FIG. 20 showed the duplicate content 2010. In some embodiments, the content in the first gallery-based tile can be blurred, as was shown in FIG. 20.

The embodiments are beneficially able to move or adjust the FOV so as to better capture the participant within the center of the gallery-based tile. In some cases, the embodiments may trigger the transition to the room view until the scene, or rather the people in the scene, are sufficiently stabilized. If the movements of the participants in the area exceed a predefined threshold, then the embodiments can trigger the display of the full room view until such time as the scene stabilizes.

If a static face is detected outside of a gallery-based tile boundary, then the embodiments can check to determine if the gallery should be recomposed to include the new face. If a gallery-based tile is determined to be empty or devoid of a participant for more than a predefined period of time, then the embodiments can be triggered to recompose the gallery or a respective gallery-based tile in the gallery and perhaps generate a smaller number of gallery-based tiles.

On the other hand, if a face remains at the boundaries of a gallery-based tile for determined period of time, then the embodiments can adjust the center of the FOV for the corresponding gallery-based tile. Thus, the participant's face can remain in the center of the FOV for the gallery-based tile.

Accordingly, the disclosed embodiments are beneficially able to generate a gallery view comprising gallery-based tiles of in-area or in-room participants. By doing so, the in-area participants are able to enjoy a similar level of dedicated exposure as online participants.

### Example Computer/Computer Systems

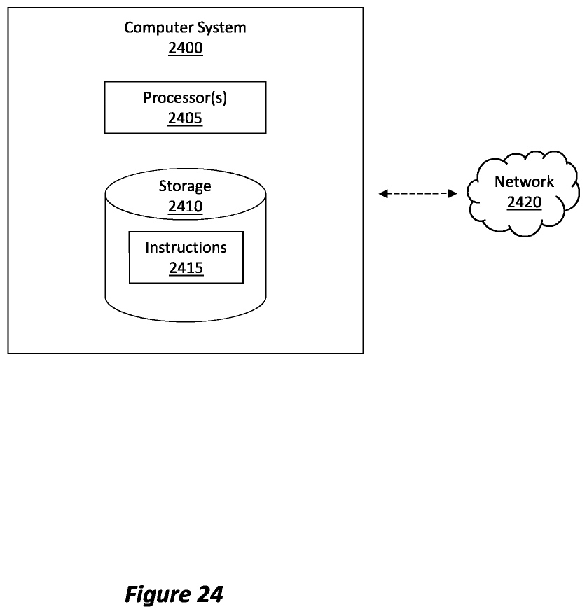

Attention will now be directed to FIG. 24 which illustrates an example computer system 2400 that may include or be used to perform any of the operations described herein. For instance, the computer system 2400 can perform any of the disclosed methods. Computer system 2400 may take various different forms. For example, computer system 2400 may be embodied as a tablet, a desktop, a laptop, a mobile device, or a standalone device, such as those described throughout this disclosure. Computer system 2400 may also be a distributed system that includes one or more connected computing components or devices that are in communication with computer system 2400.

In its most basic configuration, computer system 2400 includes various different components. FIG. 24 shows that computer system 2400 includes one or more processor(s) 2405 (aka a “hardware processing unit”) and storage 2410.

Regarding the processor(s) 2405, it will be appreciated that the functionality described herein can be performed, at least in part, by one or more hardware logic components (e.g., the processor(s) 2405). For example, and without limitation, illustrative types of hardware logic components or processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” or “engine” can refer to hardware processing units or to software objects, routines, or methods that may be executed on computer system 2400. The different components, modules, engines, and services described herein may be implemented as objects or processors that execute on computer system 2400 (e.g. as separate threads).

Storage 2410 may be physical system memory, which may be volatile, non-volatile, or some combination of the two. The term “memory” may also be used herein to refer to non-volatile mass storage such as physical storage media. If computer system 2400 is distributed, the processing, memory, or storage capability may be distributed as well.

Storage 2410 is shown as including executable instructions 2415. The executable instructions 2415 represent instructions that are executable by the processor(s) 2405 of computer system 2400 to perform the disclosed operations, such as those described in the various methods.

The disclosed embodiments may comprise or utilize a special-purpose or general-purpose computer including computer hardware, such as, for example, one or more processors (such as processor(s) 2405) and system memory (such as storage 2410), as discussed in greater detail below. Embodiments also include physical and other computer-readable media for carrying or storing computer-executable instructions or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 2400 may also be connected (via a wired or wireless connection) to external sensors (e.g., one or more remote cameras) or devices via a network 2420. For example, computer system 2400 can communicate with any number devices or cloud services to obtain or process data. In some cases, network 2420 may itself be a cloud network. Furthermore, computer system 2400 may also be connected through one or more wired or wireless networks to remote or separate computer systems(s) that are configured to perform any of the processing described with regard to computer system 2400.

A “network,” like network 2420, is defined as one or more data links or data switches that enable the transport of electronic data between computer systems, modules, or other electronic devices. When information is transferred, or provided, over a network (either hardwired, wireless, or a combination of hardwired and wireless) to a computer, the computer properly views the connection as a transmission medium. Computer system 2400 will include one or more communication channels that are used to communicate with the network 2420. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for generating a gallery-based tile of one or more participants who are participating in an online meeting, said method comprising:
accessing a video stream comprising an area view of an area in which a participant is located, said area view comprising first pixels that are representative of the area and second pixels that are representative of the participant;
segmenting the area view to identify the second pixels that are representative of the participant;
generating a field of view that surrounds a selected portion of the second pixels representative of the in-area participant;
based on an occurrence of a defined event, generating a gallery-based tile of the in-area participant, where the gallery-based tile is generated based on the field of view; and
causing the gallery-based tile of the in-area participant to be displayed while refraining from displaying an area-based tile comprising the area view.

2. The method of claim 1, wherein the field of view additionally includes a selected portion of the first pixels, and wherein the participant is an in-area participant.

3. The method of claim 1, wherein the occurrence of the defined event is based on a detected movement of the participant being under a movement threshold.

4. The method of claim 1, wherein the method further includes transitioning from displaying the gallery-based tile to displaying the area-based tile comprising the area view, and wherein said transitioning is based on an occurrence of a second event.

5. The method of claim 4, wherein the second defined event includes detection of a different participant entering the area or a detected movement of the participant exceeding a movement threshold.

6. The method of claim 1, wherein generating the gallery-based tile further includes imposing a dynamic scaling factor on the cropped field of view based on an input resolution.

7. The method of claim 1, wherein the method further includes:
segmenting the area view to identify third pixels that are representative of a different participant located in the area;
generating, within the area view, a second field of view that surrounds a selected portion of the third pixels;
based on the defined event, generating a second gallery-based tile of the different participant; and
causing the second gallery-based tile of the different participant to be displayed simultaneously with the gallery-based tile of the participant while refraining from displaying the area view.

8. The method of claim 7, wherein the method further includes:
detecting an occurrence of a second defined event; and
in response to the occurrence of the second defined event, transitioning from displaying both the gallery-based tile and the second gallery-based tile to displaying the area view, the gallery-based tile and the second gallery-based tile no longer being displayed once the area view is displayed.

9. The method of claim 1, wherein the gallery-based tile of the participant is displayed simultaneously with one or more gallery-based tiles of one or more online participants that are located remotely relative to the area.

10. The method of claim 1, wherein the gallery-based tile of the participant includes pixels representative of a head of the participant and pixels representative of shoulders of the participant.

11. A method for generating a merged tile comprising multiple in-area participants who are participating in an online meeting, said method comprising:
accessing a video stream comprising an area view of an area in which a first in-area participant and a second in-area participant are located, said area view comprising first pixels that are representative of the first in-area participant and second pixels that are representative of the second in-area participant;
causing an area-based tile comprising the area view to be displayed;
segmenting the area view to identify the first pixels that are representative of the first in-area participant and to identify the second pixels that are representative of the second in-area participant;
generating a first field of view that surrounds a first selected portion of the first pixels representative of the first in-area participant and a second field of view that surrounds a second selected portion of the second pixels representative of the second in-area participant;
determining that the second field of view overlaps the first field of view;
determining that an amount of overlap between the first field of view and the second field of view exceeds an overlap threshold;
generating a merged tile based on a third field of view, the third field of view comprising a combination of the first field of view and the second field of view; and
causing the merged tile of the first in-area participant and of the second in-area participant to be displayed while refraining from displaying the area-based tile comprising the area view.

12. The method of claim 11, wherein the merged tile is displayed simultaneously with a gallery-based tile of a third in-area participant.

13. The method of claim 12, wherein a layout by which the merged tile and the gallery-based tile are displayed corresponds to physical locations of the first in-area participant, the second in-area participant, and the third in-area participant within the area.

14. The method of claim 13, wherein the merged tile and the gallery-based tile are displayed simultaneously with one or more gallery-based tiles of one or more online participants.

15. The method of claim 11, wherein the third field of view is larger than the combination of the first field of view and the second field of view.

16. A method for transitioning between an area view and a gallery view in an online meeting platform, said method comprising:
accessing a video stream of an online meeting, said video stream comprising an area view of an area in which a first in-area participant is located, said area view comprising first pixels that are representative of the first in-area participant;
causing an area-based tile comprising the area view to be displayed in a user interface for the online meeting;
segmenting the area view to identify the first pixels that are representative of the first in-area participant;
generating a first field of view that surrounds a selected portion of the first pixels representative of the first in-area participant;
generating a first gallery-based tile of the first in-area participant based on the first field of view;
causing the first gallery-based tile of the first in-area participant to be displayed while refraining from displaying the area-based tile comprising the area view, the first gallery-based tile being displayed simultaneously with one or more gallery-based tiles of online participants;
detecting, within the area view of the video stream, second pixels that are representative of a second in-area participant who has newly entered the area; and
based on said detecting, causing the area-based tile comprising the area view to be displayed simultaneously with the one or more gallery-based tiles of the online participants while refraining from displaying the first gallery-based tile.

17. The method of claim 16, wherein the method further includes:
generating a second field of view that surrounds a selected portion of the second pixels that are representative of the second in-area participant;
determining that a movement of the second in-area participant is below a movement threshold;
in response to determining that the movement of the second in-area participant is below the movement threshold, generating a second gallery-based tile of the second in-area participant based on the second field of view;
causing the first gallery-based tile to be displayed;
causing the second gallery-based tile to be displayed;
causing the one or more gallery-based tiles of the online participants to be displayed; and
refraining from displaying the area-based tile comprising the area view.

18. The method of claim 17, wherein content from the first gallery-based tile is also included in the second gallery-based tile, and wherein the content in the first gallery-based tile is caused to be blurred.

19. The method of claim 16, wherein the method further includes:
detecting an active speaker in the online meeting;
identifying a particular gallery-based tile associated with the active speaker; and
visually emphasizing the particular gallery-based tile that is associated with the active speaker.

20. The method of claim 16, wherein the first field of view is based on a template associated with the online meeting.
